(19) United States
(12) Patent Application Publication
(10) Pub. No.: US 2013/0043611 A1
(43) Pub. Date: Feb. 21, 2013

(54) Method For Encapsulating Substances With Formation Of The Capsule Shell By Interfacial Reaction In The Centrifugal Reactor

(71) Applicants: Bernd Sachweh, Meckenheim (DE); Caroline Mages-Sauter, Weinheim (DE); Robert Engel, Speyer (DE); Andreas Bauder, Mannheim (DE); Sonja Judat, Ludwigshafen (DE); Christian Sowa, Neustadt (DE)

(72) Inventors: Bernd Sachweh, Meckenheim (DE); Caroline Mages-Sauter, Weinheim (DE); Robert Engel, Speyer (DE); Andreas Bauder, Mannheim (DE); Sonja Judat, Ludwigshafen (DE); Christian Sowa, Neustadt (DE)

(73) Assignee: BASF SE, Ludwigshafen (DE)

(21) Appl. No.: 13/587,320

(22) Filed: Aug. 16, 2012

Related U.S. Application Data
(60) Provisional application No. 61/523,859, filed on Aug. 16, 2011.

(51) Int. Cl. B01J 13/16

(52) U.S. Cl. 264/4.7

(57) ABSTRACT

Provided are methods for encapsulating substances. In certain methods, the capsule walls are obtained by interfacial reaction, wherein the interfacial reaction is carried out in a centrifugal reactor with rotating packing.

### CROSS REFERENCE TO RELATED APPLICATIONS

This application claims priority to U.S. Provisional Application No. 61/523,859, filed Aug. 16, 2011, the contents of which are hereby incorporated by reference in their entirety.

### BACKGROUND

The present invention relates to a method for encapsulating substances by interfacial reaction with formation of the capsule shell in a centrifugal reactor with rotating packing.

The encapsulation of substances by means of reactions at an interface is known per se.

Here, a core material, the disperse phase, is dispersed in a continuous phase. By bringing the two liquid, mutually immiscible phases into contact with one another, which in each case comprise the wall-forming reactive starting materials, the chemical reaction results at the interface of the emulsion droplets, with the formation of polymeric capsule walls. For example, WO 03/101606 describes the encapsulation of hydrophobic organic substances in polyurea microcapsules by interfacial polymerization, during which an aqueous phase comprising di- or polyamines and a water-immiscible phase comprising di- or polyisocyanates are brought into contact.

US 2007/0220686 describes the microencapsulation of pigments in polyurea or polyurethane microcapsules by interfacial polymerization.

U.S. Pat. No. 6,338,838 describes the production of encapsulated light protection compositions, where the outer capsule shell is likewise produced by interfacial polymerization.

WO 2009/091726 describes the microencapsulation of hydrophobic cosmetic substances by means of interfacial polymerization of isocyanates and amines with the formation of polyureas.

All of these products are obtained by batch processes. However, the product properties with regard to uniform product quality, such as, for example, encapsulation rates, particle size distribution or stability against agglomeration, are unsatisfactory. It is a further disadvantage that the up-scaling of such batch processes is not possible indefinitely and, moreover, there is the disadvantage of the discontinuous process.

Centrifugal reactors with a rotating packing are likewise known per se. Thus, U.S. Pat. No. 7,537,644 B2 describes the use of such a reactor type for the degassing of liquids. This document refers to numerous publications relating to other uses of this reactor type, for example the use for producing nanoparticles from calcium carbonate.

### SUMMARY

One aspect of the invention relates to a method for encapsulating substances. The method comprises forming capsule walls by an interfacial reaction, wherein the interfacial reaction is carried out in a centrifugal reactor with rotating packing.

In one or more embodiments, a phase A, comprising a water-immiscible organic solvent and a starting material A, and an aqueous phase B, comprising a starting material B, are converted into an emulsion in the presence of at least one surface-active substance and the substance to be encapsulated, where the formation of the capsule wall takes place at the interface of the emulsion droplets by chemical reaction of the starting materials A and B.

In some embodiments, the rotating packing comprises a fabric mesh. In one or more embodiments, the packing is rotated with a centrifugal acceleration of from about 500 g to about 5000 g.

In one or more embodiments, the centrifugal reactor is operated at pressures of from about 0.1 to about 3 MPa. In some embodiments, the centrifugal reactor has a flow rate of about 1 l/min to about 1000 l/min.

In some variants, the centrifugal reactor has a temperature is in the range of from about 0 to about 100° C. In one or more embodiments, the emulsion of phase A and phase B is an oil-in-water emulsion or a water-in-oil emulsion.

In one or more variants, the substance to be encapsulated comprises a hydrophilic or a hydrophobic substance. In some embodiments, the phase A is an emulsion of a water-immiscible organic solvent in water.

In some embodiments, the organic solvent of phase A comprises an aromatic solvent or a light oil. In one or more embodiments, the capsule wall obtained by interfacial reaction is a polycondensate.

In one or more embodiments, the capsule wall obtained by interfacial reaction consists of a polyurea, a polyurethane, a polyamide or a polycarbonate. In some embodiments, the starting material A comprises a di- or polyfunctional isocyanate.

In some variants of the invention, the starting material B comprises a di- or polyfunctional compound selected from the group of amines, hydroxylamines and alcohols. In one or more embodiments, the starting material A comprises one or more of diphenylmethane diisocyanate, polymeric diphenylmethane diisocyanate, toluene diisocyanate, isophorone diisocyanate, 1,4-phenylene diisocyanate and hexamethylene diisocyanate.

In some embodiments of the invention, the starting material B comprises a C₂-C₆-alkylenediamine. In one or more embodiments, at least one surfactant or emulsifier is used as an interface-active substance. In some variants of the invention, a lignosulfonic acid or polyalkylene oxide block copolymers or mixtures thereof are used as interface-active substance.

In one or more embodiments of the invention, the substances to be encapsulated comprise a construction chemical. In some embodiments, the substance to be encapsulated comprises a biologically active substance.

### DETAILED DESCRIPTION

Aspects of the present invention provide methods for encapsulating substances which helps to overcome the described disadvantages, and lead, in a simple manner and with good yields, to encapsulated products with good properties.

Accordingly, one aspect of the invention relates to a method has been found for encapsulating substances where the capsule walls are obtained by reactions at interfaces, wherein the interfacial reaction is carried out in a centrifugal reactor with rotating packing.

The interfacial reaction takes place in a disperse system of at least two immiscible phases, in which one disperse phase A is dispersed in a continuous phase B. The immiscible phases are ones which spontaneously form different phases upon mixing.

According to one embodiment of the invention, an emulsion, i.e. a two-phase system, in which both the phase A and also the phase B are liquid phases, is produced in the centrifugal reactor with rotating packing in the presence of an interface-active substance.

According to one embodiment of the invention, a phase A, comprising a water-immiscible organic solvent and a starting material A, and an aqueous phase B, comprising a starting material B, are converted into an emulsion in the presence of at least one surface-active substance and the substance to be encapsulated, where the formation of the capsule wall takes place at the interface of the emulsion droplets by chemical reaction of the starting materials A and B.

According to a further embodiment, a phase A is used which in turn is itself an emulsion of a water-immiscible organic solvent in water. The reactive starting substance A here is present in the organic phase. The preemulsification takes place in the presence of an interface-active substance.

According to the invention, the emulsion of phase A and phase B can be of the oil-in-water emulsion type or of the water-in-oil emulsion (W/O) type. Accordingly, the substance to be encapsulated can be a hydrophilic or a hydrophobic substance. In the case of the embodiment of a hydrophilic substance to be encapsulated, a water-in-oil emulsion is produced. In the case of the embodiment of a hydrophobic substance to be encapsulated, an oil-in-water emulsion (O/W) is produced. In one or more embodiments, the method according to the invention is used for encapsulating hydrophobic substances. The emulsion type can be adjusted via the selection of the interface-active substance. Furthermore, the emulsion type can be adjusted via the quantitative ratio of continuous phase to disperse phase.

A combination of said measures can also be used for controlling the emulsion type.

Irrespective of the selected embodiment, water-immiscible organic solvents are those solvents which spontaneously form a separate phase upon contact with water under standard conditions (at 20° C. and a pressure of 0.1 MPa).

Suitable water-immiscible organic solvents are in particular synthetic or natural aromatic or nonaromatic hydrocarbons, and also synthetic or natural oils. Suitable oils are: vegetable and animal oils, silicone oils, paraffins, triglycerides or oily monomers.

Aromatic solvents such as benzene or toluene are also suitable. Likewise of suitability are aliphatic hydrocarbons such as C₅-C₅₀-alkanes.

According to one embodiment of the invention, the capsule wall obtained by interfacial reaction is a polycondensate. Examples of suitable polycondensates include polyureas, polyurethanes, melamine-formaldehyde condensates, polyamides or polycarbonates. Examples of suitable polycondensates include polyureas, polyurethanes or a polycarbonate, in particular polyureas.

In one or more embodiments, the production of polyureas or polyurethanes are carried out as wall material for the microcapsules. Here, a di- or polyfunctional isocyanate is used as starting material A. A di- or polyfunctional compound from the group of amines, hydroxylamines or alcohols is used as starting material B.

Of suitability as starting material A are, in particular, diphenylmethane diisocyanate, polymeric diphenylmethane diisocyanate, toluene diisocyanate, isophorone diisocyanate, 1,4-phenylene diisocyanate or hexamethylene diisocyanate or mixtures thereof.

Of suitability as starting material B for producing polyureas are primarily C₂-C₆-alkylene-diamines, in particular 1,6-hexamethylenediamine, or alkylenetriamines such as diethylene-triamine. The use of triamines is particularly advisable if relatively high degrees of crosslinking of the capsule wall and less permeable wall material is desired.

Furthermore, polycondensates can be obtained by reaction of phosgene or acid dichlorides such as sebacoyl dichloride, terephthaloyl dichloride or phthaloyl dichloride with di- or polyfunctional amines, hydroxylamines or alcohols.

According to all embodiments, the encapsulation takes place in the presence of at least one interface-active substance. Suitable interface-active substances are surfactants or emulsifiers. Anionic, cationic or nonionic emulsifiers for O/W and W/O emulsions can be used.

Suitable emulsifiers for W/O emulsions can be sorbitan fatty acid esters, for example Span® types, also polysorbates, fatty acid esters of glycerol, polyglycerol esters, fatty acid esters of ethylene glycol, polyethylene glycols, amine alkoxylates (for example Quadrol®), copolymers or block copolymers of polyalkylene oxides, polyoxamines or polyisobutene-polyamine polymers (for example Glissopal®) suitable as emulsifiers. Suitable emulsifiers for O/W emulsions are, for example, sorbitan esters, glycerides, polyglyceryl esters or lignosulfonates.

Further suitable W/O or O/W emulsifiers are described in “H. P. Fiedler, Lexikon der Hilfsstoffe [Lexicon of auxiliaries], keyword: HLB values, p. 77-82, vol. 1, 4th edition, Editio Cantor Verlag Aulendorf).

The emulsifiers can be used in amounts of from 0.5 to 10% by weight, based on the disperse phase. The amount of the disperse phase, based on the total amount of the emulsion, can be 5 to 60% by weight.

Centrifugal reactors which can be used are all devices of this type known per se which are equipped with a rotating packing. According to the invention, the centrifugal reactors are operated continuously.

The ranges specified below for the process parameters are used for all specified embodiments.

The centrifugal reactor can be operated at pressures of from 0.1 MPa to 3 MPa.

In one or more embodiments, the centrifugal accelerations are in the range from 500 to 2000 g, or 800 to 1500 g [m/s²].

In some embodiments, the temperature in the centrifugal reactor can be in the range of from about 0 to 150° C., or 5 to 70° C.

The parameters are applied cumulatively, i.e. the interfacial reaction can be carried out at pressures of from 0.1 MPa to 3 MPa and centrifugal accelerations of from 500 to 2000 g and at temperatures of from 0 to 150° C. The ranges in each case are freely combinable with one another.

The flow rates in the centrifugal reactor can be 1 l/min to 1000 l/min.

The rotating packing used can be, for example, a fabric mesh which consists of metal, ceramic or a textile fabric. The fabric meshes can have mesh widths in the range from 0.5 to 10 mm.

The method according to the invention is suitable for producing microcapsules which comprise a biologically active substance as substance to be encapsulated. Suitable biologically active substances are pharmaceutical or cosmetic substances or agrochemicals. Furthermore, the method is also suitable for encapsulating inorganic substances such as calcium nitrate or iron oxide for use as concrete ingredients Likewise, inorganic or organic pigments can be microencapsulated.

### EXAMPLE

Preparation of microcapsules in an O/W emulsion

Composition:

Data in % by weight, based on the total amount of initial charge 1 and 2

Initial charge 1

19.5% by weight of Solvesso 200 (aromatic solvent—light oil, boiling range 220-290° C.)

12% by weight of Lupranat® M20S (4,4′-diphenylmethane diisocyanate)

40% by weight of water

1.63% by weight of lignosulfonic acid

1.87% by weight of Atlas G5000 (nonionic surfactant, HLB 17, polyalkylene oxide block copolymer)

Initial charge 2

24.5% by weight of water

0.5% by weight of hexamethylenediamine

Packing material: textile fabric, mesh width 2 mm

Spray lances: 5 bores with a diameter of 1 mm

Speed of the rotating packing: 5000 rpm

Diameter of the reactor drum: 160 mm

Diameter of the rotating packing: 107 mm

Packing density: 56 mm

Flow rate in the region of 0.8 1/h

The components in initial charge 1 were preemulsified using an oblique-blade stirrer or an Ultra-Turrax. The substances from both initial-charge containers were then sprayed at the same time onto the rotating packing via the spray lances. In the packing, a fine-emulsification of the drops and the formation of the capsules took place as a result of the reaction between isocyanate and amine. Following the capsule formation, the suspension was stirred gently for 3.5 h at 55° C. in order to completely cure the capsules formed. The microcapsules obtained had average particle sizes (d(0.5), volume-average) of 2.05 μm.

1. A method for encapsulating a substance, the method comprising forming capsule walls by an interfacial reaction, wherein the interfacial reaction is carried out in a centrifugal reactor with rotating packing.

2. The method according to claim 1, wherein the interfacial reaction comprises converting a phase A, comprising a water-immiscible organic solvent and a starting material A, and an aqueous phase B, comprising a starting material B, into an emulsion in the presence of at least one surface-active substance and the substance to be encapsulated, where the formation of the capsule wall takes place at the interface of the emulsion droplets by chemical reaction of the starting materials A and B.

3. The method of claim 1, wherein the rotating packing comprises a fabric mesh.

4. The method of claim 1, wherein the packing is rotated with a centrifugal acceleration of from about 500 g to about 5000 g.

5. The method of claim 1, wherein the centrifugal reactor is operated at pressures of from about 0.1 to about 3 MPa.

6. The method of claim 1, wherein the centrifugal reactor has a flow rate of about 1 l/min to about 1000 l/min.

7. The method of claim 1, wherein the centrifugal reactor has a temperature is in the range of from about 0 to about 100° C.

8. The method of claim 2, wherein the emulsion of phase A and phase B is an oil-in-water emulsion or a water-in-oil emulsion.

9. The method of claim 1, wherein the substance to be encapsulated comprises a hydrophilic or a hydrophobic substance.

10. The method of claim 2, wherein the phase A is an emulsion of a water-immiscible organic solvent in water.

11. The method of claim 2, wherein the organic solvent of phase A comprises an aromatic solvent or a light oil.

12. The method of claim 1, wherein the capsule wall obtained by interfacial reaction is a polycondensate.

13. The method of claim 1, wherein the capsule wall obtained by interfacial reaction consists of a polyurea, a polyurethane, a polyamide or a polycarbonate.

14. The method of claim 2, wherein the starting material A comprises a di- or polyfunctional isocyanate.

15. The method of claim 2, wherein the starting material B comprises a di- or polyfunctional compound selected from the group of amines, hydroxylamines and alcohols.

16. The method of claim 2, wherein the starting material A comprises one or more of diphenylmethane diisocyanate, polymeric diphenylmethane diisocyanate, toluene diisocyanate, isophorone diisocyanate, 1,4-phenylene diisocyanate and hexamethylene diisocyanate.

17. The method of claim 2, wherein the starting material B comprises a C₂-C₆-alkylenediamine.

18. The method of claim 2, wherein at least one surfactant or emulsifier is used as an interface-active substance.

19. The method of claim 2, wherein a lignosulfonic acid or polyalkylene oxide block copolymers or mixtures thereof are used as interface-active substance.

20. The method of claim 1, wherein the substances to be encapsulated comprise a construction chemical.

21. The method of claim 1, wherein the substance to be encapsulated comprises a biologically active substance.
